(19) United States
(12) Patent Application Publication
(10) Pub. No.: US 2009/0307006 A1
(43) Pub. Date: Dec. 10, 2009

(54) METHOD OF COLLABORATIVE EVALUATION INFRASTRUCTURE TO ASSESS THE QUALITY OF HEALTHCARE CLNICAL DECISION ACTORS

(75) Inventors: John Sidney Davis, II, Arlington, VA (US); Andrew Kyu Hyun Kim, Paramus, NJ (US); Ji Hyun Kim, Seoul (KR); Se Hun Park, Seoul (KR); Daby Mousse Sow, Croton-On-Hudson, NY (US); Young Ju Tak, Seoul (KR); Min Wang, Cortlandt Manor, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/132,867

(22) Filed: Jun. 4, 2008

(51) Int. Cl. G06Q 10/00

(52) U.S. Cl. 705/2

(57) ABSTRACT

A voting system employing individual healthcare actors is described wherein votes representing the relation between target measurements and actual measurements are aggregated and used to determine treatment of patients.

### BACKGROUND OF THE INVENTION

The future of health care will involve an open market ecosystem consisting of various stakeholders and actors. These actors can range from doctors, to medical sensors, to medications, to health care analysis components, all of which combine to form a health care work flow. Each of these actors can impact the efficacy of a given treatment to a given patient. The challenge in basing health care decisions on such actors is in establishing which of these actors can be trusted and relied upon for a medical decision, and which should be ignored or discounted in same. This challenge will be exacerbated as the number of actors (e.g. sensors, analysis components) is expected to grow to unmanageably large levels.

The state of the art is unprepared for evaluating the trustworthiness of individual actor components in a health care work flow stream for a given patient, and is more concerned with more global, high level concerns, such as assessing the overall healthcare process and general performance of same as related e.g. in U.S. Pat. No. 5,544,044 and U.S. Pat. No. 5,706,441. These strategies are for a different purpose as aforesaid, and do not have the granularity of evaluation needed to identify reliable actors in the decision-making process for a particular patient; nor do they inform the health care professional with relevant and timely feedback needed in this regard.

There thus remains the need for a method that uses a distributed voting mechanism to aggregate quality characterizations of each stakeholder or actor into a global notion of quality for the field of health care. Our system will allow doctors to make informed decision regarding the use of actors whose quality is in question.

Our claim deals with the collaborative evaluation of healthcare actors that are used directly by a patient or used by a doctor for the treatment of a patient.

### SUMMARY OF THE INVENTION

The invention is directed to a collaborative evaluation of healthcare actors used directly by a patient or by a healthcare profession to help determine the course of treatment. The method involves assessing individual healthcare decision actors using positive and negative votes associated with same to create a rating associated with a particular healthcare decision actor which rating is used in determining treatment for a human patient.

### DETAILED DESCRIPTION OF THE INVENTION

Without limitation, the method of the invention comprises steps (a)-(h) as follows Step (a) is providing a database (which can include a multiplicity of databases) accessible by computer. Step (b) is providing to said database at least the following healthcare decision actors: (i) a target profile for a medical device, wherein said medical device is used to measure a quantifiable physical aspect of a human body, and wherein said target profile for said medical device includes tolerance limits for the accuracy of the quantifiable physical aspect being measured by said medical device; and (ii) a target profile for a medication, wherein said medication has an expected quantifiable effect on a human patient, and wherein said target profile for said medication includes said expected quantifiable effect. Other healthcare decision actors include: healthcare analysis components such as a profile of a patient's lifestyle and/or a profile of a patient's family medical history.

Step (c) of said method is generating a vote for each healthcare decision actor as follows: (i) measuring the physical aspect of the human body in a first human patient using the medical device of (b)(i); and generating a positive vote if the value measured for said physical aspect is within said tolerance limits of said device, and generating a negative vote if the value measured for said physical aspect is beyond said tolerance limits; and (ii) ascertaining the actual effect of said medication of (b)(ii) on said first human patient after said medication has been administered; and generating a positive vote if the actual effect coincides with the expected effect, and generating a negative vote if the actual effect does not coincide with the expected effect. If other healthcare decision actors are employed, they are voted upon similarly. The votes can be binary, e.g. a positive vote is represented by the number one (“1”) and a negative vote by zero (“0”), or a scale of one to a hundred or other basis, or other voting parameters equated to positive and negative votes can be used.

Step (d) is providing at least one factor from a medical profile of said first patient to said database, said medical profile optionally including the first patient's family medical history or other information about said first patient's personal medical history or current medical condition.

Step (e) of the method is transmitting the votes generated in (c)(i) and (c)(ii) to said database, wherein said votes are individually indexed for future reference. Step (f) involves repeating steps (c), (d) and (e) for a multiplicity of patients, and compiling the votes for said multiplicity of patients in said database.

Step (g) is forming an aggregate device score associated with said medical device, comprised of the average of the votes corresponding to (c)(i) from said multiplicity of patients, and storing and indexing said aggregate device score in said database; and forming an aggregate medication score associated with said medication, comprised of the average of the votes corresponding to (c)(ii) from said multiplicity of patients, and storing and indexing said aggregate medication score in said database. The aggregate scores based on mathematical averaging can be performed by algorithms or other analysis tools known in the art.

Step (h) is accessing said database to retrieve the individual votes from step (d) or to access the aggregated device score or the aggregated medication score of step (f). E.g. a doctor looking to treat a patient (second human patient) can access the database and pull out the scores to see if the same medication on which the scores are based would be useful to the second patient; for example, the medication would have a positive aggregate score for patients with similar histories and backgrounds as correlated to the first and second patients having at the at least one factor subject of step (d) in common.

Step (i) is utilizing at least one of the votes or scores of step (g) in determining the treatment of a second human patient.

In one embodiment, a health care voting infrastructure will manage the automated and manual voting by either automated analysis (e.g. sensor analysis) or via direct and indirect stakeholder input. These voting mechanisms could possibly include the following types of information and processes: patient profile, biometric device profile, analysis profile, expected outcomes, statistical analysis, etc. The following embodiments of different practices for the steps of the invention are provided in non-limiting fashion.

### Automated Voting

In one embodiment, automated voting is used in whole or in part. Automated voting would be based on a set of predetermined profiles, in which an automated quality assessment calculation can be based upon. For example, a medication would have submitted for it an “expected-benefit profile” that would outline the expected change in the patient's physiological state during which the medication is taken. A biometric devices might have a common, parametric profile that outlines the physiologically possible readings (delta change) based upon the input of a patient's profile. A patient would submit a profile that outlines his current physiological state. An analysis component's quality assessment profile may depend on the type of analysis that is being performed. If a particular analysis component is used to detect trends in a patient's health (e.g. heart disease), then other analysis events which detect related high level medical events (e.g. heart attack) could then be used to verify the quality of the aforementioned analysis component. Other types analysis components may require manual voting by healthcare professionals (e.g. by Manual Voting). The combination of these actor's profiles and a quality assessment algorithm would be used to calculate a single vote, which is then passively (automatically) submitted into the system. The aggregation of these votes would then form the basis for a quality assessment figure of the target actor. For example: a drug medication may claim to lower blood pressure by twenty percent within a three month medication cycle. Using sensor technology, remote or in-hospital, blood pressure device readings and possibly other external information (nutritional intake information) could be used to quantify the effectiveness of the drug, and then register a “vote” in to the aggregate health care system.

### Manual Voting

In another embodiment, manual voting would be used in whole or in part, preferably as a supplement or separately as an override to automated voting. Manual voting could be used when quantifying the value of an analysis component that predicts or indicates a high level medical event (e.g. cardiac arrest). E.g. doctors who elect to use certain analysis components or work flows to monitor their patients condition may manually register a vote if they found the resultant analysis to be useful to their diagnosis or treatment of the patient. Manual voting may be presented to the doctor in either a high gradient format. For example, a scoring format of 0 to 100 could be used, if each point value could be somewhat determined objectively. Otherwise, a simple binary format (i.e. Thumbs Up or Thumbs Down) or low gradient format (1 to 5, scoring format) would be more ideal. These same formats could be used in automated voting as well. In certain cases, the manual vote into the system may not need to be explicit. For example, an analysis component that predicts or indicates a cardiac arrest might be automatically validated, in the positive, by an admission to a hospital for a cardiac arrest.

### Vote Aggregation

Automated and manual votes would be aggregated into a the same, different or central database. Each vote is preferably indexed by the profiles that were used in the vote's calculation. The aggregate score of an actor could be calculated by a simple averaging algorithm or other known mathematical method.

### Vote Presentation/Profile-Based Query

In one practice of the invention, a global rating is generated, as sufficient for most cases; however, a profile specific view of the vote is also preferably available. Since each vote is indexed by the profile data that was used to calculate the vote, a query for the quality assessment rating based upon certain heuristics is contemplated. For example, a medication might be highly successful for certain physiological profiles and not successful for others. The ability to search of ratings based upon the interested party's factors will offer a more pin-pointed rating of a healthcare actor. Profiles of healthcare related devices, analysis components, and medications in conjunction with the user's profile have a quantifiable “expected effect” or “data range”. These “effects and ranges” can be bounded by what is biologically possible and the historical context of the actor's use. The following are simple examples of this invention's logical workflow. The following examples are representative only:

### EXAMPLE 1

### Medication and Automated Voting

Based on the user's profile and the medication's generic “expected benefit” profile, a personalized patient “expected benefit” profile can be computed. Historical and current medical readings that are taken via medical device can be automatically fed into an analysis component that computes the delta of the patient's biological characteristics. This data compared with the personalized “expected benefit” profile can be used a heuristic to formulate a medication “vote”, which is then aggregated by a centralized system.

### EXAMPLE 2

### Weight Control Medication

A weight loss medication's profile states the following: patients who are over 300 lbs will lose 10% of their weight within 6 months, patients who are over 300 lbs will love 10% of their weight within 6 months, patients who are between 200 lbs and 300 lbs will lose 15% of their weight with in 6 months, patients who are between 100 lbs and 200 lbs will lose 5% of their weight with in 6 months. A patient who is 320 lbs is prescribed the aforementioned weight loss medication. The patient is a user of a remote healthcare monitoring system. The patient's physiological readings are sent and stored in a central repository. Over the next 6 months, the patient takes the weight loss medication the patient's weight is tracked daily. At the end of the 6 months, the patient's weight is now 250 lbs, which is a 22% weight loss. Based on a computation involving the patient's physical change and the patient's “personalized expected benefit” profile, a positive vote is passively (automatically) submitted into the system.

### EXAMPLE 3

### Healthcare Devices With Manual and Automated Voting

Based on the user's profile, historical (validated) device data, and the natural limits of the human body, a device's “quality” (accuracy) can be measured. The number of statistical outliers, based on the user's profile, can be used as a one heuristic to register a “automated vote” into the healthcare voting system.

### Weight Scale: Automatic Voting

A patient's weight can fluctuate with in a realistic range. For example, a patient weight, which is currently 200 lbs, can realistically fluctuate a maximum of ±10 lbs in a single day. However, if a device consistently returns data that is outside of the acceptable deviation with respect to the patient's profile, a negative vote will be passively submitted to the system.

### Weight Scale: Manual Voting

A patient takes a weight reading one hour before he goes to see his doctor. His doctor's scale is a “trusted” device. By “trusted”, the device is guaranteed to be calibrated correctly. The patient's weight reading is taken at the doctor's office, with the “trusted” device. The doctor, who also subscribes to the patient's remote healthcare system data, notices an unrealistic discrepancy between the patient's scale reading and the doctor's “trusted” device. The doctor or patient then submits a negative vote into the system.

### Weight Scale: Automatic Voting

The doctor's trusted scale verifies the patient's scale's readings. A passive (automatic) positive vote is submitted into the system.

### EXAMPLE 4

### Analysis Components With Manual and Automated Voting

Medical analysis components, which are used to do trend and real-time analysis on healthcare sensor and “external” data (any other data), are likely to play a greater role in the future of medicine. However, the output of an “analysis chain” (a group of analysis components that are used to determine an output or a “significant health event”) can be faulty—i.e. false positives or false negatives. A medical professional who receives such events can submit positive or negative votes that reflect the professional's opinion on the reliability of the analysis component or even the analysis chain.

Manual: An analysis component that calculates the likelihood of a patient having diabetes returns positive for a patient. The doctor, who receives this event, performs a battery of tests to verify or disprove the analysis component's findings. The results are proven false by the doctor's tests. The doctor submits a negative manual vote for the aforementioned diabetes detection analysis component.

Automated: An analysis component that detects the onset of cardiac arrest, returns a cardiac arrest event for a given patient. Emergency response teams and emergency doctors diagnose die patient and indicate within the patient's record that the patient experienced cardiac arrest. Patient profiles are monitored by the voting system, and the cardiac arrest diagnosis is correlated with the analysis component's findings. A positive vote is logged into the system.

### EXAMPLE 5

### Vote Presentation/Profile-Based Query

A doctor who is interested in prescribing a patient a weight loss medication, accesses the centralized voting system. The doctor indicates in a voting query that the patient has diabetes. The voting system searches the vote repository utilizing the query heuristics. The query returns a list of medications that were positive for patients with diabetes and those that have negative scores. The doctor chooses the most highly ranked medication for his patient.

One of the negatively voted medications returned by the doctor's query, is the most positively voted medication based upon no entered heuristics (no search parameters were entered).One of the positively voted medications returned by the doctor's query has been only successful with patients who suffer from diabetes.

What is claimed is:

1. A method for assessing individual healthcare decision actors using positive and negative votes associated with same to create a rating associated with a particular healthcare decision actor which rating is used in determining treatment for a human patient, which comprises:
(a) providing a database accessible by computer;
(b) providing to said database the following healthcare decision actors:
(i) a target profile for a medical device, wherein said medical device is used to measure a quantifiable physical aspect of a human body, and wherein said target profile for said medical device includes tolerance limits for the accuracy of the quantifiable physical aspect being measured by said medical device; and
(ii) a target profile for a medication, wherein said medication has an expected quantifiable effect on a human patient, and wherein said target profile for said medication includes said expected quantifiable effect; and
(c) generating a vote for each healthcare decision actor as follows:
(i) measuring the physical aspect of the human body in a first human patient using the medical device of (b)(i); and generating a positive vote if the value measured for said physical aspect is within said tolerance limits of said device, and generating a negative vote if the value measured for said physical aspect is beyond said tolerance limits; and
(ii) ascertaining the actual effect of said medication of (b)(ii) on said first human patient after said medication has been administered; and generating a positive vote if the actual effect coincides with the expected effect, and generating a negative vote if the actual effect does not coincide with the expected effect; and
(d) providing at least one factor from a medical profile of said first patient to said database, said medical profile optionally including the first patient's family medical history;
(e) transmitting the votes generated in (c)(i) and (c)(ii) to said database, wherein said votes are individually indexed for future reference;
(f) repeating steps (c), (d) and (e) for a multiplicity of patients, and compiling the votes for said multiplicity of patients in said database;
(g) forming an aggregate device score associated with said medical device, comprised of the average of the votes corresponding to (c)(i) from said multiplicity of patients, and storing and indexing said aggregate device score in said database; and forming an aggregate medication score associated with said medication, comprised of the average of the votes corresponding to (c)(ii) from said multiplicity of patients, and storing and indexing said aggregate medication score in said database
(h) accessing said database to retrieve the individual votes from step (d) or to access the aggregated device score or the aggregated medication score of step (f); and
(i) utilizing at least one of the votes or scores of step 0h) in determining the treatment of a second human patient having in common the at least one factor provided in step (d).

2. The method of claim 1 wherein said negative vote is demoninated by a zero, and said positive vote is denominated by the number one.
